(19) United States
(12) Patent Application Publication
(10) Pub. No.: US 2012/0113950 A1
(43) Pub. Date: May 10, 2012

(54) Method Of Coordinating The Transmission Resources In A Coordinated Multipoint Transmission/Receiving Communication Network

(76) Inventors: Peter Skov, Beijing (CN); Jie Zhen Lin, Beijing (CN); Chun Hai Yao, Beijing (CN)

(21) Appl. No.: 13/384,781

(22) PCT Filed: Jul. 22, 2009
(86) PCT No.: PCT/EP09/59427

§ 371 Date: Jan. 19, 2012

(51) Int. Cl. H04W 72/04

(52) U.S. Cl. 370/329

(57) ABSTRACT

A method of coordinating the transmission resources used by the UEs for UL sounding transmission in a communication network wherein multiple base stations are receiving the sounding transmission from multiple UEs. the method including defining at least one coordinated multi-point transmission set including at least one of the plurality of base station, and/or grouping at least one of the plurality of user equipments of the at least one coordinated multi-point transmission set, transmitting coordinated sounding reference signals in the at least one coordinated multi-point transmission set, and estimating the full UL channel status based on the transmitted coordinated sounding signal.

### FIELD OF INVENTION

The present invention relates to the field of methods of channel estimation in a coordinated multipoint transmission/receiving communication network, in particular in a mobile communication network like a Long Term Evolution advanced (LTE-A) communication network. Furthermore, the invention relates to a network element in a communication network, in particular, to a network element, like a mobile phone, PDA or a base station/sectors. Moreover, the invention relates to a program element, and a computer-readable medium.

### ART BACKGROUND

A new technical concept in mobile communication networks is the so called coordinated multi-point transmission and reception (CoMP) approach. Although CoMP concepts are deemed to have potential and are considered key technology in the current LTE-Advanced standardization, misgivings have been voiced about the complexity, growing pressure on the backhaul and the overhead, especially for the uplink from the terminals to base stations.

Thus, there may be a need to provide a method of or device for coordinating the transmission resources in a communication network, in particular a communication network based on the CoMP concept, which may be able to perform an efficient channel estimation.

### SUMMARY OF THE INVENTION

This need may be met by a method of coordinating the transmission resources in a communication network, a network element of a communication network, a communication network, a program element, and a computer-readable medium according to the independent claims. Advantageous embodiments of the present invention are described by the dependent claims.

According to an exemplary aspect a method of coordinating transmission resources used by user equipments for an uplink sounding transmission in a communication network comprising a plurality of user equipments, a plurality of coordinated multi-point transmission sets, and a plurality of base stations, wherein each coordinated multi-point transmission set comprises at least a respective one of the base stations, is provided, wherein the method comprises determining for at least one of the coordinated multi-point transmission sets a specific uplink coordinated sounding resource based on predetermined parameters of the coordinated multi-point transmission set, and distributing parameters characterizing the specific coordinated sounding resource to each base station of the at least one of the coordinated multi-point transmission sets.

In particular, a further step may be a receiving of an uplink sounding reference signal using the distributed specific uplink coordinated sounding resource. Moreover, an additional step may be the generating of relevant UE-specific UL multi-cell full channel estimation based on received and detected UL sounding reference signals or sounding reference signals. The generating may be performed by one or more of the base stations of the CoMP set. In particular, the determination may be performed in a coordinated manner, e.g. base stations associated to the same coordinated multi-point transmission set may select or determine in a coordinated manner the specific uplink coordinated sounding resource. Additionally, relevant parameters of the coordinated sounding resource may also be determined or decided on. Furthermore, the specific coordinated sounding resource and/or relevant parameters decisions in the CoMP set may be distributed to each member BS of this set and/or to the relevant attached UEs.

According to an exemplary aspect a method of channel estimation in a communication network comprising a plurality of user equipments and a plurality of base stations is provided, the method comprising defining at least one coordinated multi-point transmission set comprising at least one of the plurality of base stations, grouping at least one of the plurality of user equipments into the at least one coordinated multi-point transmission set, transmitting a coordinated sounding reference signal in the at least one coordinated multi-point transmission set. In particular the channel status may be estimated based on the transmitted coordinated sounding signal.

In particular, the transmitting may be between the at least one of the plurality of user equipments and the at least one of the base stations. It should be mentioned that the trans-mitting of the coordinated reference signal may be initiated by the user equipment. The estimation may be performed on the receiving site. In particular, the estimation may be performed by a processing unit which may be part of a base station. In particular, the sounding reference signal may be transmitted during a predetermined respective orthogonal sounding resource.

According to an exemplary aspect a network element for a communication network is provided wherein the network element is a member of a coordinated multi-point transmission set and is adapted to determine a specific coordinated sounding resource for UL sounding and is further adapted to distribute parameters characterizing the specific coordinated sounding resource to each base station of the at least one of the coordinated multi-point transmission sets. Additionally, the network element may be adapted to determine relevant parameters characterizing the specific coordinated sounding resource. Such relevant parameters may also be called sounding transmission parameter. In particular, the network element may be adapted to transmit the determined relevant parameters to UEs and/or relevant BSs. In particular, the network element may be adapted to determine the characterizing parameters from high layer and BS instructions and transmitting the coordinated sounding reference signal in coordinated time and frequency domain resources.

According to an exemplary aspect a network element for a communication network is provided wherein the network element is a member of a coordinated multi-point transmission set and is adapted to receive a coordinated sounding reference signal, and wherein the network element is adapted to estimate a channel status based on the transmitted coordinated sounding signal.

In particular, the network element may be a base station. However, the network element may also be a user equipment. According to an exemplary aspect a communication network is provided which comprises a plurality of base stations, a plurality of user equipments, wherein the plurality of base stations are sorted into a plurality of coordinated multi-point transmission sets, and wherein at least one of the base stations is formed by a network element according to an exemplary aspect.

According to an exemplary aspect a program element is provided, which, when being executed by a processor, is adapted to control or carry out a method according to an exemplary aspect.

According to an exemplary aspect a computer-readable medium, in which a computer program is stored which, when being executed by a processor, is adapted to control or carry out a method according to an exemplary aspect.

The use of the specific uplink coordinated sounding resource and/or an related coordinated sounding resource code which may ensure separation between each set, and especially for different user equipments (UE) in one group of UEs which may be scheduled together by BSs of the CoMP set in same UL sounding resources. Thus, further separation for resource or relevant parameters of these UEs may be ensured. Then different UEs in same scheduling group may transmit respectively separated sounding reference signals in same CoMP set coordinated resources. In particular, it may be possible that multiple base stations are receiving the sounding transmission from multiple UEs.

By using the method according to the exemplary aspect it may be possible that user equipments may only transmit one sounding signal and the sounding signal may be usable for channel estimation in all sectors of the coordinated multi-point transmission (CoMP) set of BSs which the user equipments transmitting/receiving with. Moreover, user equipments (UE) having the same CoMP set may be candidates for multi user joint transmission.

Furthermore, a good or increased performance may be achievable since it may be possible that base stations within one CoMP set may occupy same sounding resources or sounding opportunities for related UE/UEs, and sounding resources are orthogonal between each CoMP sets or between CoMP set and ordinary scenario without CoMP. Moreover, UEs which simultaneously scheduled by one CoMP set is using different sounding sequence generated by the same CoMP-set specific base sequence, which ensure orthogonality between sequences, so that inter cell and/or inter user interference may be avoided. Furthermore, it may be possible to first know the channel situation and then utilize the CoMP process, especially for precoding, afterwards.

Moreover, the overhead may be reduced by using the method according to an exemplary aspect when compared with a method where a separate base station (BS) sounding reference signal is used for each BS in a CoMP set. Thus, the uplink resource of the UE may be better used. Additionally, backward compatibility may be achievable by maximum reuse the Rel8 sounding scheme, e.g. by using CoMP-set specific parameter/configuration to replace the normal cell specific parameter/configuration and possibly reuse the UE specific relevant process within a user group.

In particular, the network element may be a user equipment, like a mobile phone, terminal, PDA or laptop, or may be a base station, or a relay node, for example.

The method may be particular useful for a communication network according to an advanced long term evolution system of 3GPP. In particular, the method may be suitable to modify the scheme which is defined in 3GPP Rel8 36.211 (latest version is v8.7.0 of June 2009) section 5.5.3 Sounding reference signal, for example. In particular, it may be used as a scheme for rel9 and may relate to study reports on LTE-A, including 36.814, e.g. section 8.2 uplink coordinated multi-point reception may be related, and 36.912. However, it may also be suitable for the rel10 LTE-A work. However, this scheme may not preclude other scenario.

A gist of an exemplary aspect may be seen in the fact that a method of coordinated transmission of sounding resources in a coordinated multi-point transmission (CoMP) set may be provided. For example, one user equipment may transmit or send a sounding reference signal to one or all base stations (BSs) of the CoMP set together on a same time frequency domain resource. Since a coordination of the used sounding resources in the communication network, e.g. between the different CoMP sets or within a single CoMP set may be performed it may be possible to use the sounding resources more efficiently while still insure that a certain sounding resource is not used by another UE in an adjacent cell/CoMP set of the communication network. Based on the transmitted coordinated sounding reference signal a channel estimation may be performed which may be used afterwards to perform an efficient demodulation and scheduling.

Next, further exemplary embodiments of the method of channel estimation are described. However, these embodiments also apply to the network element, the communication network, the program element, and the computer-readable medium.

According to an exemplary aspect the method further comprises receiving of an uplink sounding reference signal using the distributed specific uplink coordinated sounding resource.

According to an exemplary aspect of the method the specific uplink coordinated sounding resource is characterized by its time domain, frequency domain or code domain, and/or wherein the transmission of the respective coordinated sounding reference signals is done by using sets of orthogonal resources.

In particular, the relevant parameter and/or separation may also be characterized by its time domain, frequency domain or code domain. Furthermore, the respective sounding resources, e.g. of different CoMP sets, may orthogonally separated between each other by time/frequency domain separation. By using such a scheme, the CoMP-set specific coordinated sounding resource may also be orthogonal to other sounding resource of non-CoMP UEs. Moreover, different CoMP set may adopt different CoMP set specific codes, namely base sequence for generating sounding sequence. In particular, the respective sounding sequences of different UEs within one CoMP set generated basing same base sequence may be orthogonal to each other.

According to another exemplary embodiment the method further comprises defining a plurality of coordinated multi-point transmission sets, each comprising at least a respective one of the plurality of base stations and at least one of the plurality of user equipments, and transmitting a respective coordinated sounding reference signal in each of the coordinated multi-point transmission sets.

According to another exemplary embodiment of the method the transmission of the respective coordinated sounding reference signals is done with one set of orthogonal sequences.

In particular, each coordinated multi-point transmission set may select one base sequence, and UE may generate its corresponding sequence basing the base sequence, and different sequences of different UEs are orthogonal between each other. This base station may be a controlling base station or node B of the respective coordinated multi-point transmission set. Additionally or alternatively, the sounding resources may be reserved in time and frequency.

By selecting base sequences for generating the sounding reference sequences it may be possible that the base station may partition its sounding resources in between different CoMP sets. That is, a CoMP set may select a different base sequence and may use the orthogonal sounding opportunity in time and frequency domain, so that sounding interference between CoMP sets or between CoMP set and normal cell without CoMP may be avoided. Furthermore, it may be possible to use different sounding codes for transmission in each CoMP set so that the user of the same CoMP sets may use a code division multiplex process scheme.

According to another exemplary embodiment the method further comprises distributing a sounding transmission parameter characterizing the coordinated sounding reference signal.

According to another exemplary embodiment of the method the sounding transmission parameter is one out of the group consisting of coordinated multi-point transmission set specific base sequence, sequence generation relevant parameters, and sounding opportunity of time and frequency domain. It should be mentioned that of course more than one of the above mentioned sounding transmission parameters may be distributed.

According to another exemplary embodiment the method further comprises determining the sounding transmission parameter, and wherein the distributing is performed by transmitting the sounding transmission parameter to all base stations in each coordinated multi-point transmission set.

According to another exemplary embodiment the method further comprises storing the sounding transmission parameter in a storage unit. In particular, the storage unit may be part of a central functional unit of the communication network or of a base station of the CoMP set.

Summarizing an exemplary aspect may relate to a method for coordinating sounding reference signal (SRS) transmission in CoMP networks so that all node Bs which are involved in the reception and scheduling for a UE may estimate the channel state and related statistics.

It should be remembered that the number of different CoMP sets used by UEs connected to the same node B is typically low, as the CoMP set should indicate neighbour cells with high interference coupling. Moreover typically a number of UEs will have the same CoMP set, i.e. receive/transmit to the same set of node Bs.

For each of the CoMP sets (and a CoMP set with only one node B is one type of CoMP set) sounding resources may reserved in time and frequency in the concerned sectors. Transmission in these resources may be done with one set of orthogonal sequences which base sequence may be selected by the controlling node B (NB). In this way the respective base station may partition its sounding resources in between different CoMP sets. Furthermore, in each CoMP set different sounding codes may be used for transmission in order to code division multiplex the users with same CoMP set.

To support the coordinated transmission of SRS a set of sounding transmission parameters may be transmitted between BSs/sectors of the same CoMP set. Preferably, the determination of parameters related to the sounding signals may be decided by serving cell or some central control node, and may be distributed to all BSs in the same CoMP set. Examples for such parameters may be a CoMP-set specific base sequence, sequence generation relevant parameters, sounding opportunity of time and frequency domain.

With this scheme UEs may be able to only transmit one sounding code while the code may be used for channel estimation in all the sectors in the UEs' CoMP set. Moreover, UEs with same CoMP set may be candidates for multi user joint transmission. In case they are transmitting sounding in the same time frequency resource it may be ensured that users of the same CoMP set may have relevant channel information for the determining of a multi cell multi user precoding.

Thus, a method may be provided relying on the use of one single sounding transmission from UE to estimate channels in all NBs of one CoMP set in order to avoid UE power loss and sounding resource waste. Furthermore, sounding resources may be orthogonalized based on the CoMP set, so that sounding transmission from UE's with different CoMP set may be orthogonalized in time-frequency while sounding transmission from UE's with same CoMP set it using code domain. A sounding transmission code/sequence may be derived from a CoMP set specific base sequence.

Since the sounding resources may be used and/or reused in a coordinated way between different cells, it may be possible to insure that a certain sounding resource is not used by another UE in adjacent cell or of other CoMP set. Thus, in particular the signal to noise ratio on the reference signal may be increased compared to an uncoordinated sounding resource reusing in interfering sectors so that the channel estimation accuracy may be increased. The method is related to the concept creation for the long term evolution advanced (LTE-A) system of 3GPP. In particular, it may be related to the feature coordinated multipoint transmission and reception (CoMP) which is currently being discussed in 3GPP while this scheme is not precluded other usage case.

The aspects and exemplary embodiments defined above and further aspects of the invention are apparent from the example of embodiment to be described hereinafter and are explained with reference to these examples of embodiment.

### BRIEF DESCRIPTION OF THE DRAWINGS

FIG. 1 shows a schematically flow chart of a method according to an exemplary embodiment.

FIG. 2 shows a schematically flow chart of a method according to an exemplary embodiment.

FIG. 3 schematically shows a communication network.

FIG. 4 schematically shows a code orthogonalization between users with same CoMP set and orthogonalization sounding resource in time/frequency domain between different CoMP sets.

FIG. 5 schematically illustrates the scheduling of sounding reference signals for two CoMP sets' UEs and ordinary UE.

### DETAILED DESCRIPTION

The illustration in the drawings is schematic. It is noted that in different figures, similar or identical elements are provided with the similar or identical reference signs.

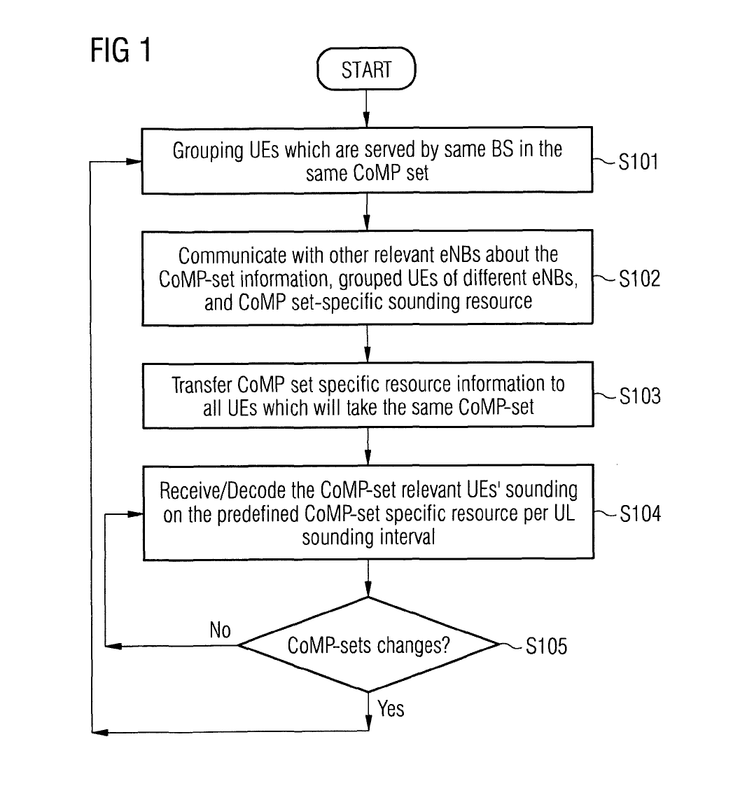

With reference to FIG. 1 a schematically flow chart of a method of coordinating the transmission resources or estimating channels in a communication network according to an exemplary embodiment will be described. FIG. 1 particularly describes the operation of a base station of a coordinated multi-point transmission (CoMP) set for uplink (UL) sounding. After starting the process 100 in a first step 101 all user equipments (UE) are grouped which may be served by a specific base station (BS) or node B may be served in a same CoMP set. In a second step 102 the specific serving base station may communicate with other relevant base stations of the communication network to transfer or send CoMP set information. Examples for such CoMP set information may be grouped UEs of different base stations or node Bs, CoMP set specific sounding resources, relevant decisions made, and CoMP set specific resources registered or stored in a central function or central network element, like a base station. In a third step 103 the CoMP set information may be transmitted or communicated to all UEs which may take or belong to the same CoMP set. For all UEs or some UEs this transmission may be performed simultaneously from the nodeBs of step 102, e.g. via system information. In a next step 104 transmitted sounding reference signals of UEs of the CoMP set should be received and/or decoded in a predetermined or predefined UL sounding resource interval which may be specific for the CoMP set. At a next step 105 a decision may be made whether the CoMP set changes or is altered, e.g. a new UE or even a base station enters. In case no changes are determined the process may return to step 104. In case it is determined that a change occurred the process may start from the beginning, e.g. at step 101.

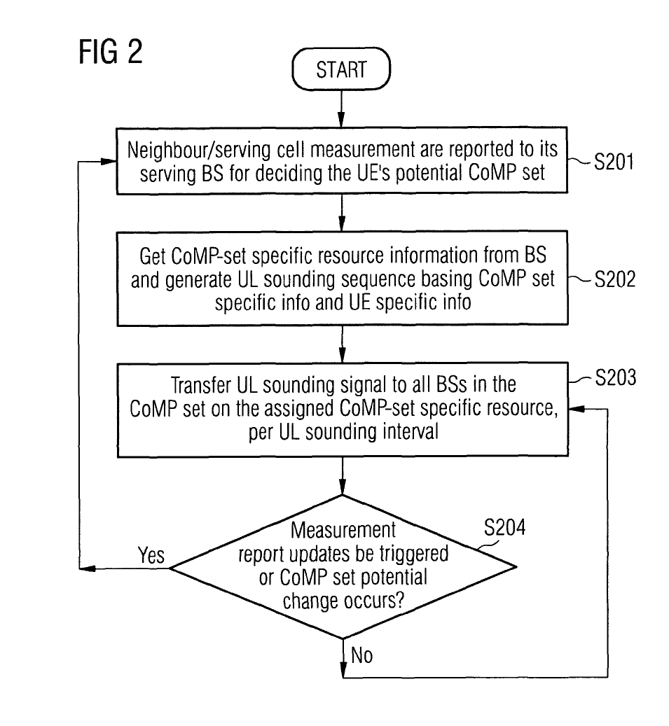

With reference to FIG. 2 a schematically flow chart of a method of coordinating the transmission resources or estimating channels in a communication network according to an exemplary embodiment will be described. FIG. 2 particularly describes the operation of a user equipment of a CoMP set for UL sounding. After starting the process 200 in a first step 201 a measured neighbouring or serving cell report may be transmitted to a serving base station from the UE so that the base station may decide on or determine a potential CoMP set of the UE. Alternatively or additionally the UE itself may suggest its potential CoMP set and/or report the CoMP set to the base station. In a next step 202 the UE may get or read specific resource information relating to the CoMP set and may generate an UL sounding sequence or sounding signal based on CoMP set specific info and on UE specific info. In a next step 203 the UL transfers the sounding signal to all base stations of its CoMP set, wherein the transferring is performed on the assigned specific sounding resource, e.g. during per UL sounding interval. In a next step 204 measurement report updates may be triggered or CoMP set potential changes may occur. In case one of the both occurs the process goes back to step 201. In case neither of both occurs the process goes back to step 203 and the next sounding resource signal may be transferred by the UE in a new sounding interval.

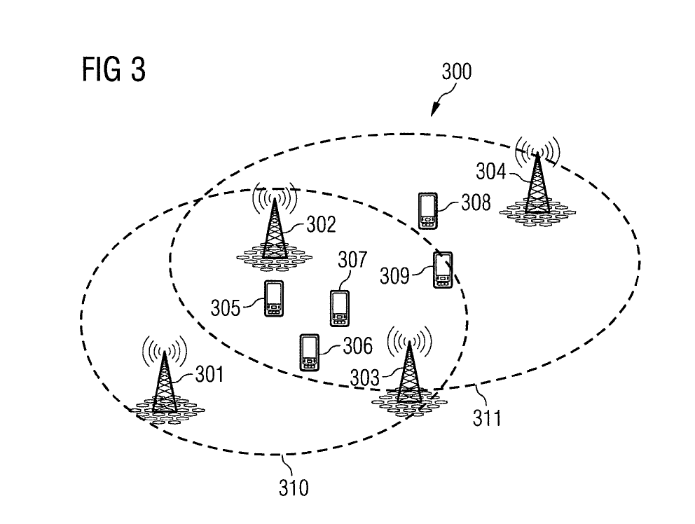

With reference to FIG. 3 a communication network 300 will be described. The communication network may be a cellular mobile communication network.

The communication network 300 comprises two CoMP sets 310 and 311 each comprising a corresponding base station 301,302,303 and 302,303,304, respectively. Furthermore, a plurality of network elements 305, 306, 307, 308 and 309 are schematically depicted in FIG. 3. However, the communication network may of course comprise a much higher number of base stations and network elements, which mal be formed by mobile phones, computers, PDA base stations of cordless telephones or the like, i.e. every communication system which is suitable for a wireless communication. Each of the plurality of network elements is a member of a CoMP set and it should be mentioned that each CoMP set may have of course more than one BS assigned to. One of the base stations of each CoMP set may form the serving base station, which performs the process described in connection with FIG. 1. In FIG. 3, CoMP set 310 include base station 301,302,303, and UE 305,306,307. CoMP sets 311 include base station 302,303,304, and UE 308, 309.

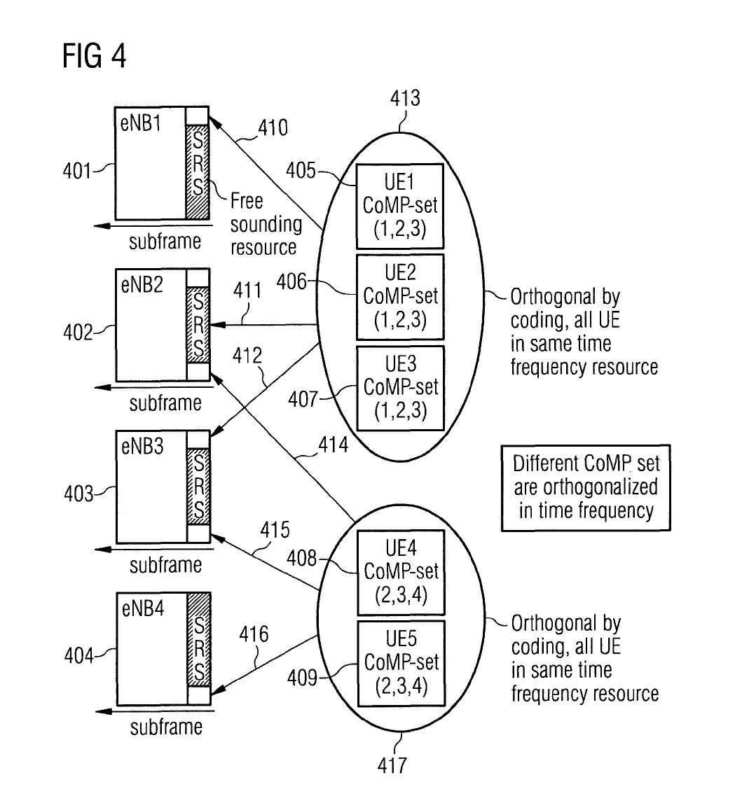

FIG. 4 schematically shows a code orthogonalization between users with same CoMP set in a communication network. FIG. 4 schematically shows a first enhanced node B (eNB) 401, a second eNB 402, a third eNB 403, and a fourth eNB 404. Further, five UEs 405, 406, 407, 408, and 409 are indicated, wherein the first, second and third UEs are served by the first, second and third eNBs which is indicated by the arrows 410, 411, and 412 and form a first CoMP set 413 indicated by the ellipse 413. The fourth and fifth UEs are served by the second, third and fourth eNBs which is indicated by the arrows 414, 415, and 416 and form a second CoMP set 417 indicated by the ellipse 417.

In particular, UEs in the first CoMP set 413 transmit its sounding reference signals in the same first resource, which is indicated by the fact that all three arrows 410, 411, and 412 are directed to the same resource schematically depicted in the subframe. Other resources during the same time interval remain unused, i.e. form free sounding resources. One of the resources unused by the first CoMP set is used by the second CoMP set 417 which is indicated by the arrows 414, 415, and 416.

It should be mentioned that the sounding reference signals of the UEs of each CoMP set may be orthogonal coded while all UEs may use the same time frequency resource, while the sounding reference signals of different CoMP set may be orthogonalized in time and/or frequency domain. Furthermore, it should be mentioned that one eNB might see a few different CoMP sets depending on the number of neighbours.

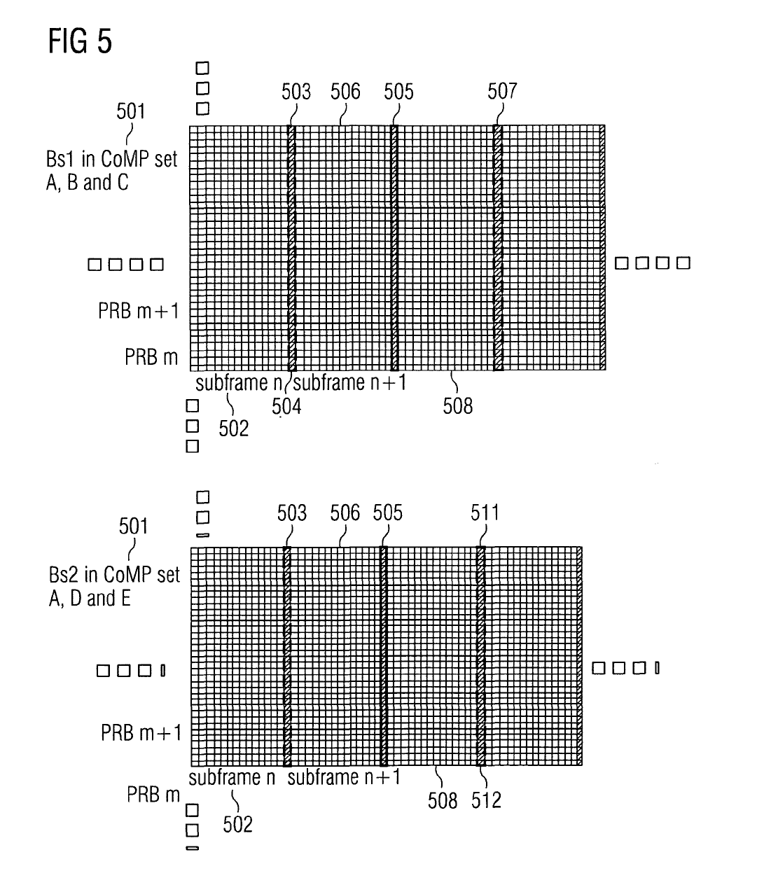

FIG. 5 schematically illustrates the scheduling of sounding reference signals for different CoMP sets.

In particular, the upper portion of FIG. 5 shows the scheduling for a first base station 501 which is part of CoMP sets A, B and C. Thus, the respective resources may be scheduled for the different CoMPS sets. During a first subframe n 502 some sounding resources 503 are reserved for CoMP set A, while other sounding resources 504 are reserved for CoMP set B. Sounding resources 505 of another subframe n+1 506 may be reserved for attached UEs which are not part of any CoMP set, while sounding resources 507 of a yet another subframe 508 are reserved for CoMP set C.

The lower portion of FIG. 5 shows the scheduling for a second base station 510 which is part of CoMP sets A, D and E. Thus, the respective resources may be scheduled for the different CoMPS sets. During the first subframe n 502 the sounding resources 503 are already reserved for CoMP set A (cf. last paragraph). The sounding resources 505 of another subframe n+1 506 may already be reserved for attached UEs which are not part of any CoMP set. Sounding resources of the yet another subframe 508 may be rescheduled for sounding reference signals of CoMP set D indicated by 511 and for sounding reference signals of CoMP set E, indicated by 512.

Assuming the first BS 501 and the second BS 510 BS2 are the only two BSs on the same CoMP set A. Through cooperation between each other, BS 501 and 510 have reserved the same sounding opportunities on each BSs (including time-frequency domain resources, selected same CoMP-set specific base sequence for SRS sequence generation, and also same decision on any cell-specific relevant parameters and configurations of a normal (non-CoMP) sounding). Thus UEs in CoMP set A will transmit sounding reference signals generated basing the decided base sequence and UE specific configuration (frequency hopping, etc) of the CoMP set A on the same reserved sounding time-frequency domain resource.

Summarizing a method according to an exemplary embodiment may solve the problem of estimating the UL channel to different base stations with sounding reference signals (SRS) transmitted from one single UE. Once the channel state information is obtained at the node B it may be forwarded to the serving/controlling node B so that the serving node B may be able to generate an estimate of the full UL multi cell channel. Knowing the multi cell UL channel at the serving/controlling node B may be useful especially in TDD mode where channel reciprocity means that UL and DL channel are similar. Using the multi-cell channel the scheduler may orthogonalize users which in Re18 type of scenario would interfere with each other. The method may also be suitable for FDD systems because knowledge of UL channel may be used to do channel aware UL link adaptation, scheduling and MIMO precoding.

Finally, it should be noted that the above-mentioned embodiments illustrate rather then limit the invention, and that those skilled in the art will be capable of designing many alternative embodiments without departing from the scope of the invention as defined by the appended claims. In the claims, any reference signs placed in parentheses shall not be construed as limiting the claims. The word “comprising” and “comprises”, and the like, does not exclude the presence of elements or steps other than those listed in any claim or the specification as a whole. The singular reference of an element does not exclude the plural reference of such elements and vice-versa. In a device claim enumerating several means, several of these means may be embodied by one and the same item of software or hardware. The mere fact that certain measures are recited in mutually different dependent claims does not indicate that a combination of these measures cannot be used to advantage.

### LIST OF REFERENCE SIGNS

100 Start
101 Grouping of UEs
102 Communication of CoMP set information to BSs
103 Transfer of resource information to UEs
104 Receive CoMP set sounding
105 Determination whether CoMP set changes
200 Start
201 Report of service cell measurement
202 Get CoMP set specific resource information
203 Transfer sounding signal to BSs
204 Determination whether update is triggered
300 Communication network
301 Base station 1
302 Base station 2
303 Base station 3
304 Base station 4
305-309 UEs
310 CoMP set 1
311 CoMP set 2
401 BS1
402 BS2
403 BS3
404 BS4
405 UE1
406 UE2
407 UE3
408 UE4
409 UE5
410-412 Arrows
413 CoMP set 1
414-416 Arrows
417 CoMP set 2
501 BS1
502 First subframe
503 Reserved sounding resource CoMP set A
504 Reserved sounding resource CoMP set B
505 Sounding resource
506 Second subframe
507 Reserved sounding resource CoMP set C
508 Third subframe
510 BS2
511 Reserved sounding resource CoMP set D
512 Reserved sounding resource CoMP set E

1. A method of coordinating transmission resources used by user equipments for an uplink sounding transmission in a communication network comprising a plurality of user equipments, a plurality of coordinated multi-point transmission sets, and a plurality of base stations, wherein each coordinated multi-point transmission set comprises at least a respective one of the base stations, the method comprising:
determining for at least one of the coordinated multipoint transmission sets a specific uplink coordinated sounding resource based on predetermined parameters of the coordinated multi-point transmission set, and
distributing parameters characterizing the specific coordinated sounding resource to each base station of the at least one of the coordinated multi-point transmission sets.

2. The method according to claim 1, further comprising: receiving of an uplink sounding reference signal using the distributed specific uplink coordinated sounding resource.

3. The method according to claim 1,
wherein the specific uplink coordinated sounding resource is characterized by its time domain, frequency domain or code domain, and/or
wherein the transmission of the respective coordinated sounding reference signals is done by using sets of orthogonal resources.

4. The method according to claim 1,
wherein the sounding transmission parameter is one out of the group consisting of:
coordinated multi-point transmission set specific base sequence,
sequence generation relevant parameters, and
sounding opportunity of time and frequency domain.

5. The method according to claim 1, further comprising:
determining the sounding transmission parameter.

6. The method according to claim 1, further comprising:
storing the sounding transmission parameter in a storage unit.

7. A network element for a communication network, wherein the network element is a member of a coordinated multi-point transmission set and adapted to determine a specific coordinated sounding resource for UL sounding and is further adapted to distribute parameters characterizing the specific coordinated sounding resource to each base station of the at least one of the coordinated multi-point transmission sets.

8. A communication network comprising:
a plurality of base stations,
a plurality of user equipments,
wherein the plurality of base stations and the plurality of user equipments are sorted into a plurality of coordinated multi-point transmission sets, and
wherein at least one of the base stations or user equipment is formed by a network element according to claim 7.

9. A program element, which, when being executed by a processor, is adapted to control or carry out a method according claim 1.

10. A computer-readable medium, in which a computer program is stored which, when being executed by a processor, is adapted to control or carry out a method according to claim 1.
